(19) United States
(12) Patent Application Publication
(10) Pub. No.: US 2020/0284274 A1
(43) Pub. Date: Sep. 10, 2020

(54) SELF ACTUATING RAM ACTUATOR FOR WELL PRESSURE CONTROL DEVICE

(71) Applicant: Noble Drilling Services Inc., Sugar Land, TX (US)

(72) Inventor: Robert van Kuilenburg, Sugar Land, TX (US)

(21) Appl. No.: 16/811,834

(22) Filed: Mar. 6, 2020

Related U.S. Application Data
(63) Continuation of application No. PCT/US2018/049279, filed on Aug. 31, 2018.
(60) Provisional application No. 62/554,670, filed on Sep. 6, 2017.

(51) Int. Cl. F15B 15/28; E21B 33/06

(52) U.S. Cl. CPC F15B 15/2815; F15B 15/04; E21B 33/062

(57) ABSTRACT

A method for operating a ram in a well pressure control apparatus includes communicating a control signal to at least one of a rotary motor and a source of pressurized fluid to operate at least one of the motor and the source of pressurized fluid to operate a ram actuator. A parameter related to position of the ram actuator is measured during operation of the actuator. Operation of the ram actuator is automatically stopped when the measured parameter indicates the ram actuator is fully extended or fully retracted.

### CROSS REFERENCE TO RELATED APPLICATIONS

Continuation of International Application No. PCT/US2018/049279 filed on Aug. 31, 2018. Priority is claimed from U.S. Provisional Application No. 62/554,670 filed on Sep. 6, 2017. Both the foregoing applications are incorporated herein by reference in their entirety.

### STATEMENT REGARDING FEDERALLY SPONSORED RESEARCH OR DEVELOPMENT

Not Applicable

### NAMES OF THE PARTIES TO A JOINT RESEARCH AGREEMENT

Not Applicable.

### BACKGROUND

This disclosure relates generally to the field of drilling wells through subsurface formations. More specifically, the disclosure relates to apparatus for controlling release of fluids from such wellbores, such devices called blowout preventers (BOPs).

BOPs known in the art have one or more sets of opposed “rams” that are urged inwardly into a housing coupled to a wellhead in order to hydraulically close a wellbore under certain conditions or during certain wellbore construction operations. The housing may be sealingly coupled to a wellhead or casing flange at the top of the well. The rams, when urged inwardly, may either seal against a pipe string passing through the BOP and/or seal against each other when there is no pipe (or when the pipe is present but must be cut or “sheared.” Movement of the rams is performed by hydraulically operated actuators.

BOPs known in the art used in marine operations may be coupled to a wellhead at the bottom of a body of water such as a lake or the ocean. In such BOPs, electrical power may be supplied from a drilling unit above the water surface, which may be converted to hydraulic power by a motor operated pump proximate the BOP. There may also be hydraulic oil tanks having hydraulic fluid under pressure proximate the BOP in order to provide the necessary hydraulic pressure to close the rams in the event of failure of the hydraulic pump or drive motor.

A typical hydraulically actuated BOP is described in U.S. Pat. No. 6,554,247 issued to Berkenhof et al.

### SUMMARY

A method for operating a ram in a well pressure control apparatus according to one aspect includes communicating a control signal to at least one of a rotary motor and a source of pressurized fluid to operate at least one of the motor and the source of pressurized fluid to operate a ram actuator. “Fluid” in the present context is used to mean liquid, gas and/or combinations thereof. A parameter related to position of the ram actuator is measured during operation of the actuator. Operation of the ram actuator is automatically stopped when the measured parameter indicates the ram actuator is fully extended or fully retracted.

Some embodiments further include determining a performance of the ram actuator by comparing, in a controller disposed proximate the ram actuator, the measured parameter related to the position of the ram actuator to values of the control signal.

Some embodiments further include communicating the measured parameter to a location away from the ram actuator.

In some embodiments, the location comprises at least one of a platform on the surface of a body of water, a ram manufacturing facility and a ram repair and maintenance facility.

In some embodiments, the control signal is generated automatically by a controller disposed proximate the ram actuator in response to measurements of pressure in a well.

In some embodiments, the control signal comprises variable operating rate with respect to time.

In some embodiments, the variable rate with respect to time is optimized for conditions in a well.

Some embodiments further include measuring fluid pressure in the well, temperature proximate the ram actuator and using the measured parameter related to position, the measured fluid pressure and the measured temperature to adjust at least one parameter of the control signal.

Some embodiments include at least one of: determining when to remove the ram actuator from service when any parameter used to determine the performance of the ram actuator crosses a selected threshold; and measuring a parameter related to particle concentration in at least one of the pressurized fluid and fluid in an atmospheric pressure chamber, and determining when to remove the ram actuator from service when the parameter related to particle concentration crosses a selected threshold.

Some embodiments further include: removing the ram actuator from service; transporting the ram actuator to a facility for at least one of repair and remanufacturing; and returning the ram actuator to service after the at least one or repair and remanufacturing.

Some embodiments further include: generating an identification signal in the controller to enable remote identification of the ram actuator; and tracking movement of the ram actuator during each of a plurality of actions performed beginning with removal of the ram actuator from service and returning the ram actuator to service.

Some embodiments further include transmitting directly to at least one user at least the measured parameter related to position.

In some embodiments, the control signal is communicated from a mobile wirelessly connected device to the ram actuator by at least one of direct communication and Internet connected communication.

A pressure control apparatus according to another aspect comprises a housing having a through bore. A ram and actuator are affixed to the housing. A closure element is movable by the actuator to open and close the through bore. A controller is in signal communication with the actuator and is operable to cause movement of the actuator in response to a control signal detected by the controller. At least one position sensor is coupled to at least one of the actuator and the ram to measure a parameter related to position of the at least one of the actuator and the ram. A signal output of the position sensor is in communication with the controller. The controller is operable to automatically stop operation of the actuator in response to signals from the at least one position sensor indicative of the ram being fully closed and/or fully open. The controller is operable to start operation of the actuator in response to a control signal.

Some embodiments further comprise a communication device in signal communication with the controller, the communication device operable to transmit a signal indicative of output of the at least one position sensor and to receive the control signal.

In some embodiments, the actuator comprises a motor rotatably coupled to an actuator rod.

In some embodiments, the motor comprises an electric motor.

In some embodiments, the actuator comprises a piston disposed in a cylinder operatively coupled to a source of fluid pressure.

In some embodiments, the at least one position sensor comprises a pressure sensor.

Some embodiments further comprise a sensor responsive to solid particles present in fluid discharged by the source of fluid pressure.

Other aspects and possible advantages will be apparent from the description and claims that follow.

### BRIEF DESCRIPTION OF THE DRAWINGS

FIG. 1 shows an example embodiment of marine drilling a well from a floating drilling platform wherein a blowout preventer is installed on the wellhead.

FIG. 2 shows a side view of an example embodiment of a well pressure control apparatus according to the present disclosure.

FIG. 3 shows a top view of the example embodiment of an apparatus as in FIG. 1.

FIGS. 4A and 4B show an example embodiment of a self-actuating ram actuator.

FIG. 5 shows an example embodiment of the ram actuator of FIGS. 4A and 4B communicating performance information to a manufacturer or other pressure control apparatus service entity.

FIG. 6 shows an example apparatus as in FIGS. 4A and 4B being operated externally.

FIG. 7 shows example embodiments of ram operating strategies enabled by the apparatus shown in FIGS. 4A and 4B.

FIG. 8 shows a flow chart of an example embodiment of the apparatus shown in FIGS. 4A and 4B wherein control parameters to operate the ram are updated based on measured response of the ram actuation to earlier values of control parameters.

FIG. 9 shows a flow chart of an automated maintenance and replacement method enabled by the apparatus shown in FIGS. 4A, 4B and 5.

FIGS. 10 and 11 show example embodiments of a subsea BOP stack and surface BOP stack, respectively, using ram actuators as shown in FIGS. 4A and 4B/

### DETAILED DESCRIPTION

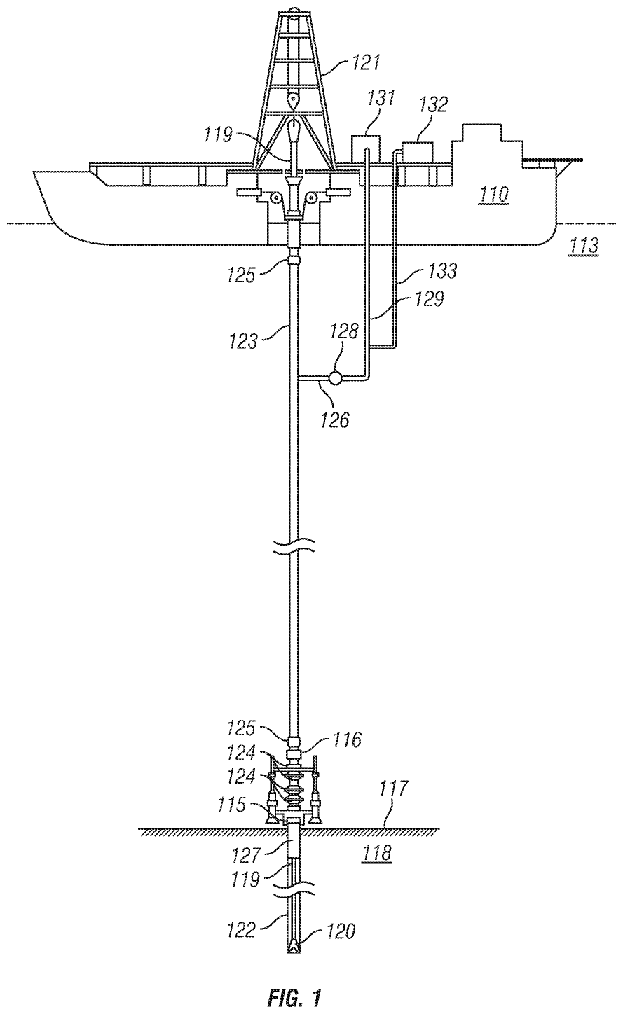

FIG. 1 is provided to show an example embodiment of well drilling that may use well pressure control apparatus according to various aspects of the present disclosure. The example embodiment of drilling shown in FIG. 1 is beneath a body of water, however an apparatus and method according to the present disclosure is not limited to marine drilling and the scope of the present disclosure is accordingly not so limited. FIG. 1 shows a drilling vessel 110 floating on a body of water 113 and equipped with an apparatus according to the present disclosure. A wellhead 115 is positioned proximate the sea floor 117 which defines the upper surface or “mudline” of sub-bottom formations 118. A drill string 119 and associated drill bit 120 are suspended from a derrick 121 mounted on the drilling vessel 110 and which extends to the bottom of a wellbore 122. A length of structural casing 127 may extend from the wellhead 115 to a selected depth into the sub-bottom formations 118 above the wellbore 122. Concentrically receiving the drill string 119 is a riser 123 which is positioned between the upper end of a blowout preventer stack 124 and the drilling vessel 110. Located at each end of riser 123 are ball joints 125 to enable lateral movement of the drilling vessel 110 with reference to the wellhead 115.

Positioned near the upper portions of the riser pipe 123 is a lateral outlet 126 which connects the riser pipe 123 to a low line 129. An outlet 126 is provided with a throttle valve 128 (e.g., a controllable orifice choke). The flow line 129 extends upwardly to a separator 131 aboard the drilling vessel 110, thus providing fluid communication from the interior of the riser pipe 123 through the flow line 129 to the drilling vessel 110. Also aboard the drilling vessel 110 is a compressor 132 for conducting pressurized gas into a gas injection line 133 which extends downwardly from the drilling vessel 110 and into the lower end of the flow line 129. The foregoing components may be used in so-called “dual gradient” drilling, wherein modification and/or pumping the returning drilling fluid to the drilling vessel 110 may provide a lower hydrostatic fluid pressure gradient in the riser 123 than would be the case if the drilling fluid were not so modified or pumped as it returns to the drilling vessel 110. For purposes of defining the scope of the present disclosure, such fluid pressure gradient modification need not be used in any particular embodiment. The example embodiment disclosed herein is intended to serve only as an example and is not in any way intended to limit the scope of the present disclosure.

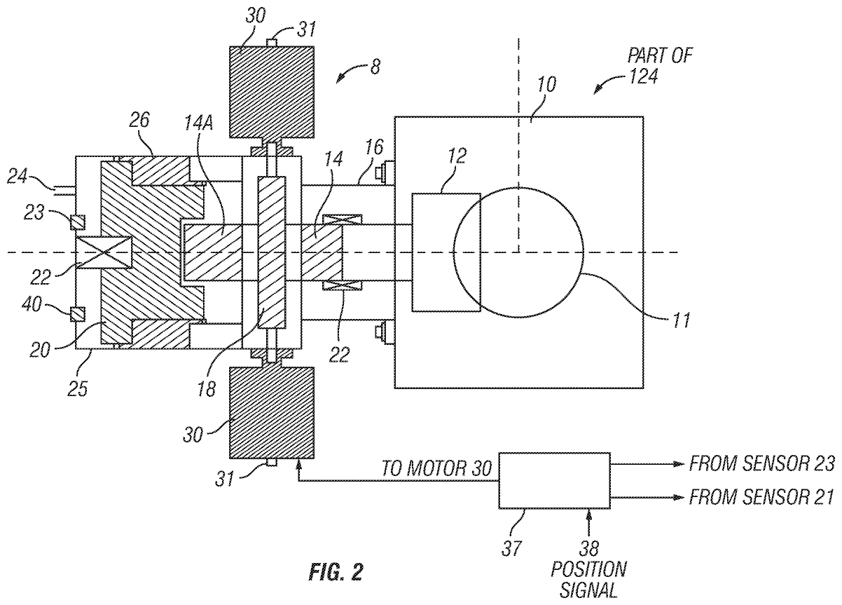

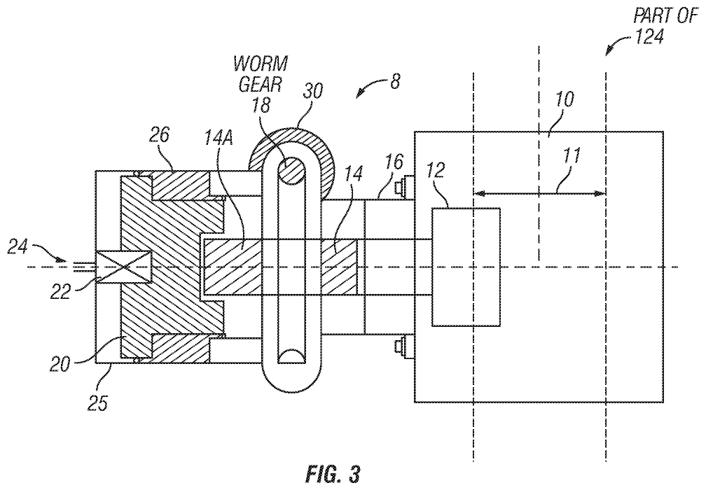

In order to control the hydrostatic pressure of the drilling fluid within riser 123, in some embodiments drilling fluids may be returned to the drilling vessel 110 by means of the flow line 129. As with ordinary marine drilling operations, drilling fluids are circulated down through the drill string 119 to the drill bit 120. The drilling fluids exit the drill bit 120 and return to the riser 123 through the annulus defined by the drill string 119 and the wellbore 122. A departure from ordinary drilling operations may then occur in some embodiments. Rather than return the drilling fluid and drilled cuttings through the riser 123 to the drilling vessel 110, the drilling fluid may be maintained at a level in the riser 123 which is somewhere between the upper ball joint 125 and the outlet 126. This fluid level may be related to the desired hydrostatic pressure of the drilling fluid in the riser 123 which will not fracture the sub-bottom formation 118, yet which will maintain well control. The riser 123 may be connected to the top 116 of a wellhead (including components described with reference to numeral 124) or blowout preventer as in FIGS. 2 and 3, for example, using threaded couplings or bolted flanges.

In such embodiments, drilling fluid may be withdrawn from the riser 123 through the lateral outlet 126 and then returned to the drilling vessel 110 through the flow line 129. The throttle valve 128, which controls the rate of fluid withdrawal from the riser 123, moves the drilling fluid into the low line 129. Pressurized gas from compressor 132 may be transported down the gas injection line 133 and injected into the lower end of the flow line 129. The injected gas mixes with the drilling fluid to form a lightened three-phase fluid consisting of gas, drilling fluid and drill cuttings. The lightened three-phase fluid has a density substantially less than the original drilling fluid and has sufficient “lift” to flow to the surface.

FIG. 2 shows a top view and FIG. 3 shows a side elevation view of an example well pressure control apparatus 8 according to various aspects of the present disclosure. The well pressure control apparatus may be a blowout preventer (BOP) which includes a housing 10 having a through bore 11 for passage of well tubular components used in the drilling and completion of a subsurface wellbore. For clarity of the illustration, functional components of the BOP are shown on only one side of the housing 10. It will be appreciated that some example embodiments of a BOP may include substantially identical functional components coupled to the housing 10 diametrically opposed to those shown in FIG. 2 and FIG. 3.

The through bore 11 may be closed to passage of fluid by inward movement of a closure element 12 such as a ram into the through bore 11. In some embodiments which include functional components on only one side of the housing 10, the ram 12, when fully extended into the through bore 11 may fully close and seal the through bore 11 as in the manner of a gate valve. In other embodiments of a BOP in which substantially identical components are disposed on opposed sides of the housing 10, the ram 12 may when fully extended contact an opposed ram (not shown in the Figures) that enters the through bore 11 from the other side of the housing 10. In the present example embodiment, the ram 12 may be a so called “blind” ram, which sealingly closes the through bore 11 to fluid flow when no wellbore tubular device is present in the through bore 11. In some embodiments, the ram may be a so called “shear” ram that may be operated to sever a wellbore tubular or other device disposed in the through bore 11 so that the BOP may be sealingly closed in an emergency when removal of the tubular or other device is not practical. In other embodiments, the ram 12 may be a “pipe” ram that is configured to sealingly engage the exterior surface of a wellbore tubular, e.g., a segment of drill pipe, so that the wellbore may be closed to escape of fluid when the tubular is disposed in the through bore 11 without the need to sever the tubular.

The ram 12 may be coupled to a ram shaft 14. The ram shaft 14 moves longitudinally toward the through bore 11 to close the ram 12, and moves longitudinally away from the through bore to open the ram 12. The ram shaft 14 may be sealingly, slidably engaged with the housing 10 so that a compartment usually referred to as a “bonnet” 16 may be maintained at surface atmospheric pressure and/or exclude entry of fluid under pressure such as ambient sea water pressure when the well pressure control apparatus 8 is disposed on the bottom of a body of water in marine drilling operations.

The ram shaft 14 may be coupled to an actuator rod 14A. In the present embodiment, the actuator rod 14A may be a jack screw, which may be in the form of a cylinder with helical threads formed on an exterior surface thereof. In the present example embodiment, the actuator rod 14A may include a recirculating ball nut (not shown for clarity in the Figures) engaged with the threads of the actuator rod 14A. A worm gear 18 may be placed in rotational contact with the ball nut, if used, or with the actuator rod 14A. In some embodiments, other versions of a planetary roller type may be used to link the actuator rod 14A to the worm gear 18. Rotation of the worm gear 18 will cause inward or outward movement of the actuator rod 14A, and corresponding movement the ram shaft 14 and ram 12.

The worm gear 18 may be rotated by at least one, and in the present embodiment, an opposed pair of motors 30. The motor(s) 30 may be, for example, electric motors, hydraulic motors or pneumatic motors.

An outward longitudinal end of the actuator rod 14A may be in contact with a torque arrestor 22. The torque arrestor 22 may be any device which rotationally locks the actuator rod 14A. The piston 20 may be disposed in a cylinder 25 that is hydraulically isolated from the bonnet 16. One side of the piston 20 may be exposed to an external source of pressure 24, for example and without limitation, hydraulic pressure from an accumulator or pressure bottle, pressurized gas, or ambient sea water pressure when the pressure control apparatus 8 is disposed on the bottom of a body of water. The other side of the piston 20 may be exposed to reduced pressure 26, e.g., vacuum or atmospheric pressure such that inward movement of the piston 20 is substantially unimpeded by compression of gas or liquid in such portion of the cylinder 25. The other side of the piston 20 may be in contact with another torque arrestor 22. The other torque arrestor 22 may be fixedly mounted to the cylinder 25.

In the present example embodiment, a pressure sensor 21 may be mounted between the piston 20 and the torque arrestor 22. The pressure sensor 21 may be, for example a piezoelectric element disposed between two thrust washers. The pressure sensor 21 may generate a signal corresponding to the amount of force exerted by the piston and the actuator rod 14A against the ram 12 to open or close the ram 12. Another pressure sensor 40 may be used as shown in FIG. 2. In some embodiments, a longitudinal position of the actuator rod 14A or piston 20 may be measured by a linear position sensor 23, for example a linear variable differential transformer or by a helical groove formed in the exterior surface of the piston 20 and a variable reluctance effect sensor coil (not shown).

As may be observed in FIG. 2, the motor(s) 30 may have a manual operating feature 31, such as a hex key or other torque transmitting feature to enable rotation of the worm gear 16 in the event of motor failure. The manual operating feature 31 may be rotated by a motor, e.g., on a remotely operated vehicle (ROV) should such operation become necessary.

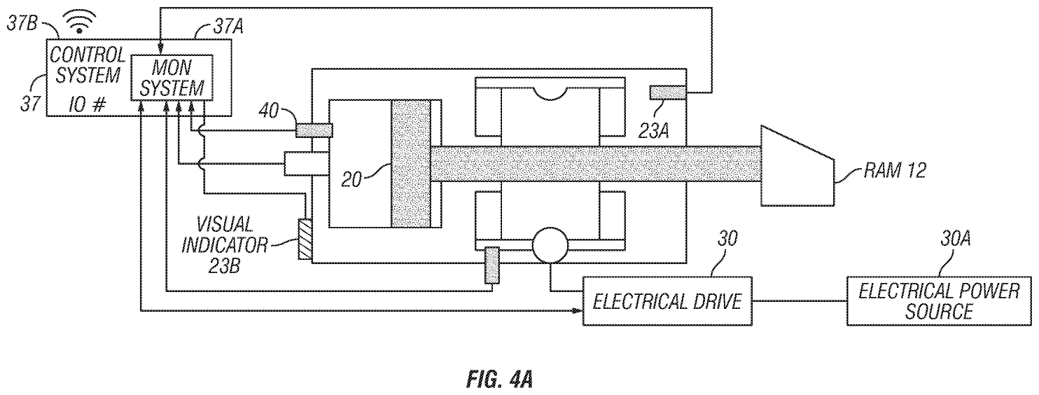

Referring once again to FIG. 2, in some embodiments, the well pressure control apparatus 8 may be made to operate in “closed loop” mode, whereby an instruction may be sent to the apparatus 8 to open the ram 12 or to close the ram 12. For such purpose a controller 37, which may be any form of microcontroller, programmable logic controller or similar process control device, may be in signal communication with the pressure sensor 21 and the linear position sensor 23. A control output from the controller 37 may be functionally coupled to or conducted to the motor(s) 30. When a command is received (see 37B in FIG. 4A) by the controller 37 to close the ram 12, the controller 37 will operate the motor(s) 30 to rotate the worm gear 16 and cause the actuator rod 14A to move the ram 12 toward the through bore 11. Fluid pressure acting on the other side of the piston 20 will increase the amount of force exerted by the actuator rod 14A substantially above the force that would be exerted by rotation of the motor(s) 30 alone. When pressure measured by the pressure sensor 21 increases, and when the linear position sensor 23 measurement indicates the ram 12 is fully extended into the through bore 11, the controller 37 may stop rotation of the motor(s) 30. The reverse process may be used to open the ram 12 and stop rotation of the motor(s) 30 when the sensor measurements indicate the ram 12 is fully opened. In such manner, opening and closing the ram 12 may be performed without the need for the user to monitor any measurements and manually operate controls; the opening and closing of the ram 12 may be fully automated after communication of an open or close signal or command to the controller 37.

FIGS. 4A and 4B show an example embodiment of a ram actuator as explained with reference to FIGS. 2 and 3, which may include additional components to enable some degree of automation of operation of the ram actuator, and to store and communicate information related to the performance of the ram actuator so that ram actuator response to control signals can be periodically or continuously, and information concerning required maintenance may be automatically communicated to a service provider or manufacturer.

A pressure sensor 40 may measure hydraulic pressure on one side of the piston 20, as in the embodiments shown in FIGS. 2 and 3. An optical sensor 23B may be used in conjunction with the linear position sensor (23 in FIG. 2) to determine position of the piston 20 within the cylinder 25. Measurements from the optical sensor 23B may also be used to determine a relative concentration of any solid particles present in pressurized fluid used to move the piston 20. Such determination may be used in some embodiments, explained further below, to determine when the ram actuator requires removal and servicing. A second pressure sensor 23A may be disposed in the bonnet 16 so that measurement of pressure in the through bore (11 in FIG. 2) may be measured. A combination temperature/pressure/particle count (e.g., optical) sensor 33 may be arranged to measure temperature, pressure and a parameter related to particle count within fluid contained in an atmospheric pressure chamber 16A enclosing the worm gear and actuator rod (FIG. 2). Signals from the foregoing sensors may be communicated to the controller 37.

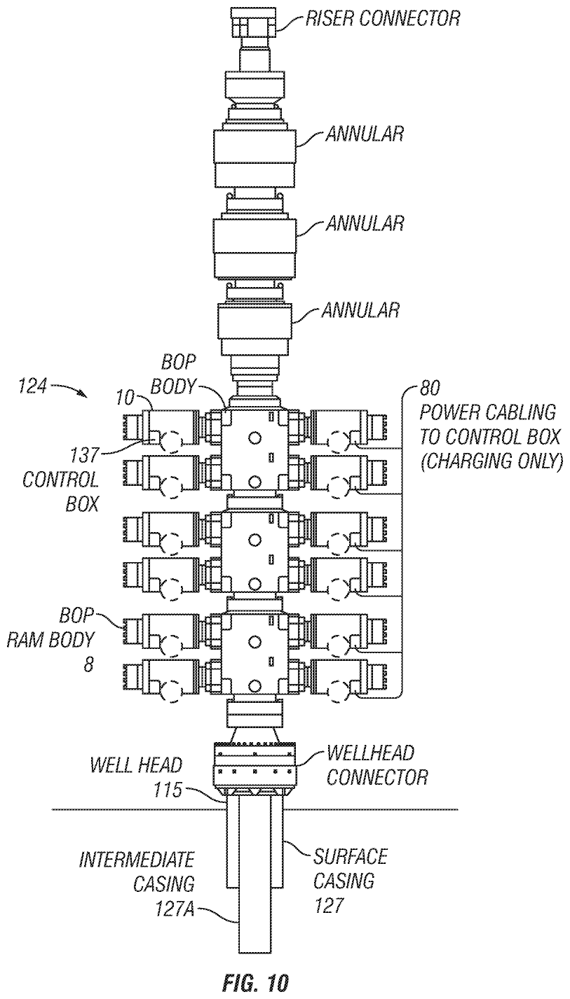

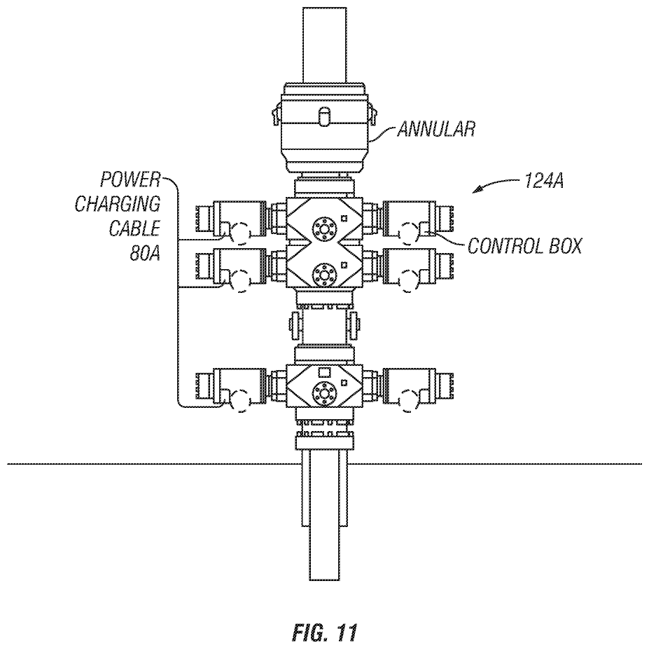

An electrical power source 30A may be provided to operate the motor(s) 30 and the controller 37. The electrical power source 30A may be self-contained, such as batteries disposed in the atmospheric chamber 16A, or may be conducted over an electrical cable (FIGS. 9 and 10) from the drilling vessel (10 in FIG. 1), or a combination thereof.

In the present example embodiment, the controller 37 may comprise a processor, programmable logic controller, programmable microcomputer or any similar device, shown at 37A) that can execute instructions stored on a computer readable medium or stored in a storage device within the processor 37A. The processor 37A may be in signal communication with a transceiver 37B. The transceiver 37B may be “hard wired” to a communication device in signal communication with another controller deployed on the drilling vessel (110 in FIG. 1) for water-bottom deployed ram actuators (see FIG. 10) or may be a wireless communication device, for example and without limitation, radio, wireless Internet, BLUETOOTH transceiver or any other two way communication device. BLUETOOTH is a registered trademark of Bluetooth Special Interest Group (“SIG”), Inc., Suite 350, 5209 Lake Washington Boulevard, Kirkland, Wash. 98033.

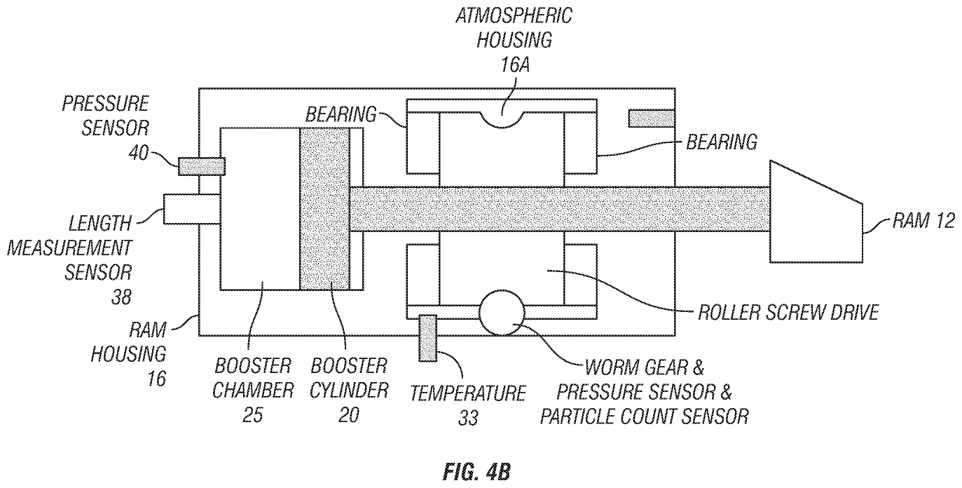

FIG. 5 shows an example embodiment of the apparatus shown in FIGS. 4A and 4B wherein signals corresponding to measurements made by the various sensors shown in those figures may be communicated to a maintenance and/or manufacturing facility 42 on a periodic or continuous basis. The signals communicated may comprise values of control signals used to operate the motor (30 in FIG. 2) and hydraulic pressure used to move the piston (20 in FIG. 2) and values of the measurements made by the sensors shown in FIGS. 4A and 4B. The facility 42 may have disposed therein computers or computer systems (not shown) that can calculate the performance status of the ram actuator. In some embodiments, such performance status may comprise comparing control signal values, for example, control signals to operate the motor (30 in FIG. 4B) and to enable hydraulic pressure to be applied to the piston (20 in FIG. 4B), and their corresponding expected sensor measurements to the actual sensor measurements made and communicated to the controller (37 in FIGS. 4A and 4B). Anomalous sensors measurements, for example, those indicative of excessive motor temperature when moving the ram actuator, excessive hydraulic fluid pressure, slow measured rate of movement of the ram actuator with respect to hydraulic pressure and motor rotation, and excessive particle concentration in the fluid used to operate the piston (20 in FIG. 4B) may be used to determine faulty operation of the ram actuator and/or changes in actuator performance that may be known to be associated with or may be indicative of future faulty performance of the ram actuator. The foregoing will be explained in further detail with reference to FIG. 9, wherein an automated maintenance and replacement method is described.

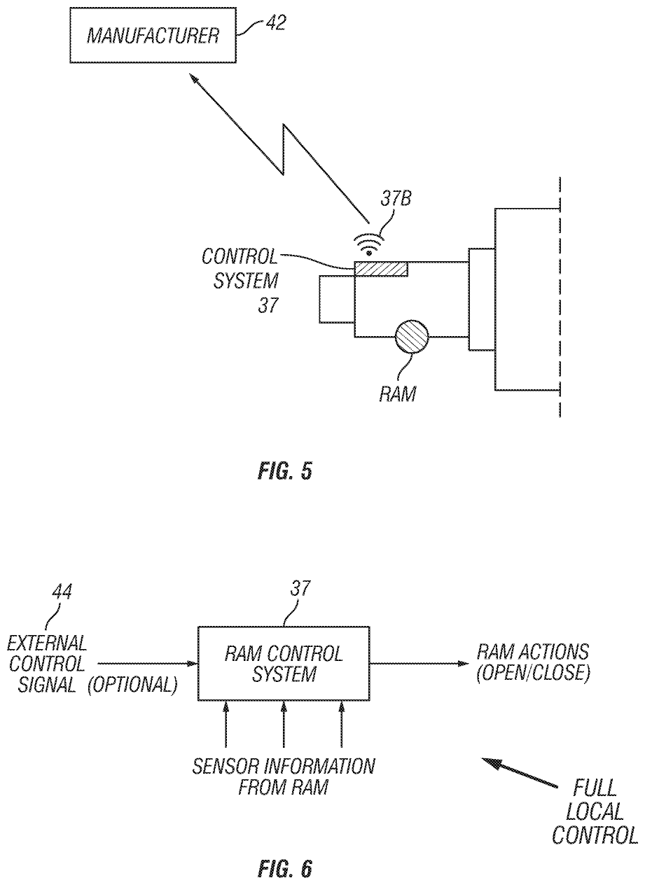

FIG. 6 shows an example of autonomous or automatic control of operation of the ram actuator by programming suitable instructions in the controller 37. When so programmed, the controller 37 may automatically operate the motor (30 in FIG. 2) and supply hydraulic pressure to the piston (20 in FIG. 2) in response to measurements of linear position, hydraulic pressure, motor rotation, temperature and fluid pressure in the throughbore (11 in FIG. 2) so that the ram actuator may operate fully autonomously. Full autonomous operation may include measurement of pressure in the throughbore (11 in FIG. 2) and a response by the controller 37 to close the ram (12 in FIG. 2) when the measured pressure and/or a time derivative of the measured pressure crosses a selected threshold. In some embodiments, a command signal may be communicated from an external source 44 to the controller 37 to open or to close the ram actuator; in such embodiments, detection of the “open ram” or “close ram” signal by the controller 37 may cause the controller to operate the motor (30 in FIG. 4A) and supply/relieve hydraulic pressure to the piston (20 in FIG. 4A) to automatically close and/or open the ram actuator.

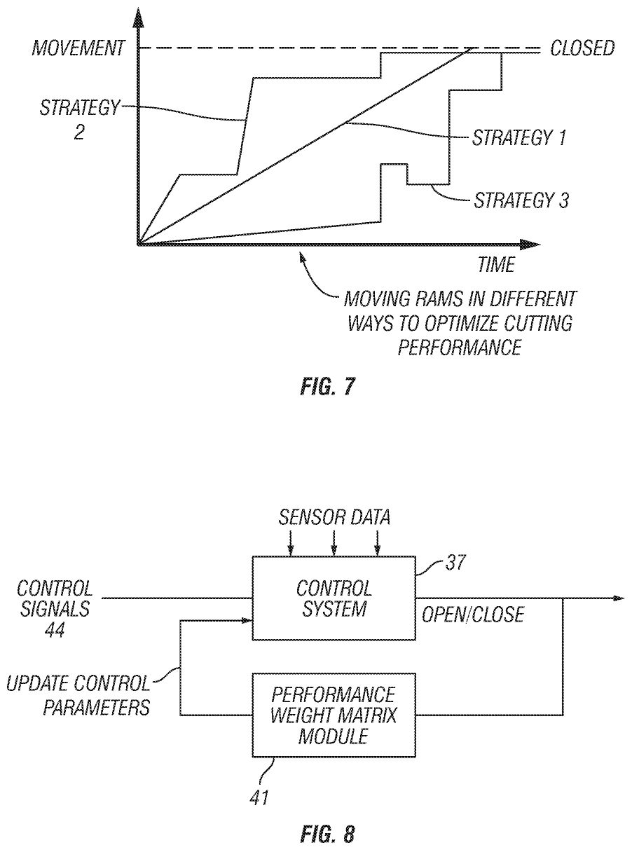

FIG. 7 shows graphs of ram actuator position with respect to time for different ram actuator operating characteristics that may be programmed into the controller (37 in FIG. 4A) to operate the ram actuator to open and close at different and selectable time variable rates. For example, one opening and closing rate is shown as a linear function of position with respect to time at STRATEGY 1. A “stair step” opening/closing position function with respect to time (e.g., alternating rapid movement and slow movement) is illustrated as STRATEGY 2. A variable stair step (which may include opening and closing rate reversals as well as monotonic and/or stair step increases/decreases) opening/closing position with respect to time is illustrated at STRATEGY 3. In some embodiments, the controller 37 may be programmed to automatically optimize the ram actuator position with respect to time for different ram actuator operating characteristics.

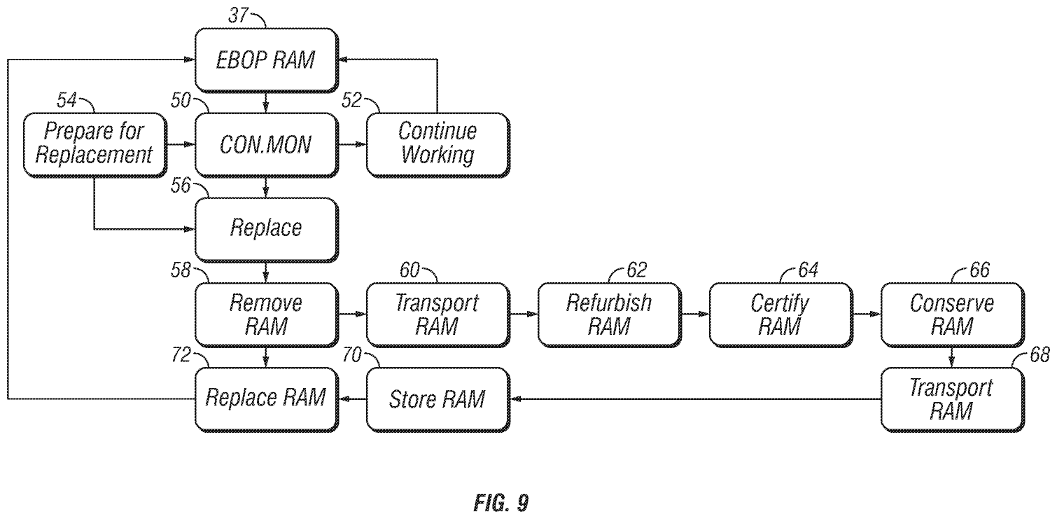

FIG. 8 shows a block diagram of using the measurements made by the sensors shown in FIGS. 4A and 4B in the controller to automatically change the control parameter signals generated by the controller 37 to operate the ram actuator. For example and without limitation, if the STRATEGY 1 is implemented by the controller 37 and measurements made by the sensors are indicative of position with respect to time changing more slowly than what has been programmed as STRATEGY 1 (in FIG. 7), then the controller 37 may adaptively increase either or both of the pressure applied to the piston (20 in FIG. 2) and the operating speed of the motor (30 in FIG. 2) so that the measured position with respect to time more closely matches the preprogrammed position with respect to time. A performance weight matrix 41 allows identical controllers to behave differently based on operational parameter changes (e.g., mud weights, well depths, operational stage, etc.), specific RAM performance (based on measured performance during calibration) and environmental changes (such as water depth, temperatures, etc). Since there is a wireless connection this weight matrix can be updated if and when needed“. The ability to tune the controller is of great operational advantage” Other possible control parameter updating methods will occur to those skilled in the art. Such updating of control parameters may be performed automatically on a periodic or continuous basis, or may be performed when a signal is communicated externally from a signal source 44 to the controller 37. The signal source 44 may be wired and/or wireless as explained with reference to FIGS. 4A, 4B and 5.

FIG. 9 shows a flow chart of an automated method for determining when a ram actuator should be removed from service for repair, maintenance and/or reconditioning. As explained with reference to FIG. 8, performance of the ram actuator may be continuously determined in the controller 37 by comparing the sensor measurements (FIGS. 4A and 4B) to the values of the control signals used to operate the motor (30 in FIG. 2) and/or the piston (20 in FIG. 2). At 50, the ram actuator performance may be continuously monitored along with the total time the ram actuator has been in service and the number of times the ram actuator has been tested and/or used in service to control well pressure (“service parameters”). If during the performance monitoring all service parameters indicative of a need to remove the ram actuator from service are within predetermined limits or have not crossed respective thresholds, the ram actuator will remain in service as shown at 52. If any one or more service parameters is determined in the controller 37 to be outside the predetermined limits or crosses a predetermined threshold, a signal may be generated and communicated at 54 (e.g., using the communications transceiver 37B in FIG. 4A) to advise the operator and/or the service facility that the ram actuator should be removed from service, at 56. When such signal indicating the need to remove the ram actuator from service is generated, the ram actuator may be removed from service at 58. For purposes of the method described with reference to FIG. 9, service procedures applicable to the ram actuator may be likewise applied to the ram (12 in FIG. 2), wherein the ram actuator and ram are acted upon as a unit. The removed ram actuator may be transported at 60 to the facility (42 in FIG. 5). At 62, the facility may recondition or remanufacture the ram actuator. The facility 42 may perform certification testing on the ram actuator at 64. The facility 42 may store or conserve the ram actuator at 66 for eventual transport, at 68, to the drilling or production platform where the ram actuator was previously used, or may transport the ram actuator to any other drilling or production platform having a BOP stack or single BOP housing (see FIGS. 10 and 11) that is compatible with the particular ram actuator. The ram actuator may be stored, at 70, at the location of the drilling or production platform for eventual installation if and as necessary. If and as necessary a same type of ram actuator installed on the BOP stack or BOP housing (FIGS. 9 and 10) may be replaced, at 72, by the stored ram actuator. By implementing the method shown in flow chart form in FIG. 9, maintenance and replacement scheduling for the ram actuator(s) may be automated, as well as automating inventory tracking of to be serviced and fully serviced ram actuators.

FIG. 10 shows a BOP stack 124 including a plurality of rams/ram actuators as explained with reference to FIGS. 2 through 5. The BOP stack 124 shown in FIG. 10 may be affixed to a wellhead 115 proximate the water bottom in a sub-bottom well. The BOP stack 124 may be affixed to the top of a surface casing 127 as explained with reference to FIG. 1. The sub-bottom well may comprise an intermediate casing 127A, shown in FIG. 10 for illustrative purposes only and not to limit the scope of the present disclosure. In FIG. 10, a power supply cable 80 may be connected to each ram actuator 8 either or both to operate the electrical components therein and to keep batteries therein fully charged. The power supply cable 80 may also be used to communicate signals between each controller (37 in FIG. 4A) and the drilling platform (110 in FIG. 1) for such water bottom deployed BOP stacks 124. In some embodiments, signals may be communicated between the ram actuators and the surface using acoustic telemetry through the water. Such telemetry systems are known in the art.

FIG. 11 shows a corresponding BOP stack 124A used at the surface. The surface may be, for example, on the drilling platform (110 in FIG. 1) or on the land surface for land-based wells. In the embodiment of FIG. 11, the transceivers (37B in FIG. 4A) may be wireless as explained with reference to FIG. 4A. In some embodiments, operational and condition monitoring data can be transmitted directly to other users in addition to or in substitution for communicating such data to the facility (42 in FIG. 9). In some embodiments, a power cable 80A may supply electrical power to operate the respective motor (30 in FIG. 2) and controller (37 in FIG. 4A) in each ram actuator.

In some embodiments, the ram actuator may be controlled with wirelessly connected mobile devices such as tablets, smart phones and the like. In some embodiments, the communication device (37B in FIG. 4A) may be directly or indirectly in signal communication with the Internet. In such embodiments, the wirelessly connected mobile devices may be used to operate and/or monitor performance of the ram actuator using an Internet connection. In some embodiments, the wirelessly connected mobile devices may be in signal communication with the communication device (37B in FIG. 4A) directly such as by radio signal, WiFi communication protocol (IEEE standard 802.1(a) et seq.), BLUETOOTH communication protocol or any other wireless communication protocol.

In some embodiments, e.g., for multiple ram actuators such as shown in FIGS. 10 and 11, each ram actuator may be in signal communication with other ram actuators in the BOP stack and the respective controllers (37A in FIG. 4A). In such embodiments, the respective controllers may be programmed to synchronize operation of each ram actuator to the operation of one or more of the other ram actuators in the BOP stack (124 in FIGS. 10 and 124A in FIG. 11).

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A method for operating a ram in a well pressure control apparatus, comprising:
communicating a control signal to at least one of a rotary motor and a source of pressurized fluid to operate at least one of the motor and the source of pressurized fluid to operate a ram actuator;
measuring a parameter related to position of the ram actuator during operation thereof; and
automatically stopping operation of the ram actuator when the measured parameter indicates the ram actuator is fully extended or fully retracted.

2. The method of claim 1 further comprising:
determining a performance of the ram actuator by comparing, in a controller disposed proximate the ram actuator, the measured parameter related to the position of the ram actuator to values of the control signal.

3. The method of claim 1 further comprising communicating the measured parameter to a location away from the ram actuator.

4. The method of claim 3 wherein the location comprises at least one of a platform on the surface of a body of water, a ram manufacturing facility and a ram repair and maintenance facility.

5. The method of claim 1 wherein the control signal is generated automatically by a controller disposed proximate the ram actuator in response to measurements of pressure in a well.

6. The method of claim 1 wherein the control signal comprises variable operating rate with respect to time.

7. The method of claim 6 wherein the variable rate with respect to time is optimized for conditions in a well.

8. The method of claim 7 further comprising measuring fluid pressure in the well, temperature proximate the ram actuator and using the measured parameter related to position, the measured fluid pressure and the measured temperature to adjust at least one parameter of the control signal.

9. The method of claim 2 further comprising at least one of:
determining when to remove the ram actuator from service when any parameter used to determine the performance of the ram actuator crosses a selected threshold; and
measuring a parameter related to particle concentration in at least one of the pressurized fluid and fluid in an atmospheric pressure chamber, and determining when to remove the ram actuator from service when the parameter related to particle concentration crosses a selected threshold.

10. The method of claim 9 further comprising:
removing the ram actuator from service;
transporting the ram actuator to a facility for at least one of repair and remanufacturing; and
returning the ram actuator to service after the at least one or repair and remanufacturing.

11. The method of claim 10 further comprising:
generating an identification signal in the controller to enable remote identification of the ram actuator; and
tracking movement of the ram actuator during each of a plurality of actions performed beginning with removal of the ram actuator from service and returning the ram actuator to service.

12. The method of claim 1 further transmitting directly to at least one user at least the measured parameter related to position.

13. The method of claim 1 wherein the control signal is communicated from a mobile wirelessly connected device to the ram actuator by at least one of direct communication and Internet connected communication.

14. The method of claim 1 wherein the pressurized fluid comprises liquid and/or gas.

15. A pressure control apparatus, comprising:
a housing having a through bore;
an actuator affixed to the housing and having a closure element movable by the actuator to open and close the through bore;
a controller in signal communication with the actuator and operable to cause movement of the actuator in response to a control signal detected by the controller;
at least one position sensor coupled to at least one of the actuator and the ram to measure a parameter related to position of the at least one of the actuator and the ram, a signal output of the position sensor in communication with the controller; and
wherein the controller is operable to automatically stop operation of the actuator in response to signals from the at least one position sensor indicative of the ram being fully closed and/or fully open, the controller operable to start operation of the actuator in response to a control signal.

16. The apparatus of claim 15 further comprising a communication device in signal communication with the controller, the communication device operable to transmit a signal indicative of output of the at least one position sensor and to receive the control signal.

17. The apparatus of claim 15 wherein the actuator comprises a motor rotatably coupled to an actuator rod.

18. The apparatus of claim 17 wherein the motor comprises an electric motor.

19. The apparatus of claim 15 wherein the actuator comprises a piston disposed in a cylinder operatively coupled to a source of fluid pressure.

20. The apparatus of claim 19 wherein the at least one position sensor comprises a pressure sensor.

21. The apparatus of claim 19 further comprising a sensor responsive to solid particles present in fluid discharged by the source of fluid pressure.
